(19) United States
(12) Patent Application Publication
(10) Pub. No.: US 2007/0002750 A1
(43) Pub. Date: Jan. 4, 2007

(54) Generic Real Time Scheduler for Wireless Packet Data Systems

(75) Inventors: Aimin Sang, Plainsboro, NJ (US); Xiaodong Wang, New York, NY (US); Mohammad Madihian, Plainsboro, NJ (US)

Correspondence Address: NEC LABORATORIES AMERICA, INC., 4 INDEPENDENCE WAY, PRINCETON, NJ, 08540, US

(73) Assignee: NEC LABORATORIES AMERICA, INC., Princeton, NJ (US)

(21) Appl. No.: 11/276,381

(22) Filed: Feb. 27, 2006

Related U.S. Application Data
(60) Provisional application No. 60/696,217, filed on Jul. 1, 2005.

(51) Int. Cl. H04J 3/14; H04B 7/216

(52) U.S. Cl. 370/238; 370/335

(57) ABSTRACT

A real-time scheduler is disclosed for packet data services in a wireless communication network. A hierarchical scheduler is also disclosed which has the flexibility to handle mixed real-time and non-real-time users.

### CROSS-REFERENCE TO RELATED APPLICATIONS

This application claims the benefit of U.S. Provisional Application No. 60/696,217, entitled “GENERIC REAL-TIME SCHEDULER FOR WIRELESS PACKET DATA SYSTEMS,” filed Jul. 1, 2005, the contents of which are incoporated by reference herein.

### BACKGROUND OF INVENTION

The invention relates to wireless communication networks and, more particularly, to scheduling of packet data services in wireless communication networks.

There are a variety of architectures which have been devised for next-generation packet data services in wireless communication networks, including the CDMA2000 High Data Rate (HDR) system and the WCDMA High Speed Data Packet Access (HSDPA) system. In such systems, a shared downlink communication channel is expected to support multiple users of heterogeneous quality-of-service (QoS). Numerous design proposals have been devised for an efficient scheduler for such services. See, e.g., M. Andrews et al., “Providing Quality of Service over a Shared Wireless Link,” IEEE Commun. Mag., pp. 150-54 (February 2001); S. Shakkottai et al., “Scheduling Algorithms for a Mixture of Real-Time and Non-Real-Time Data in HDR,” in 17th Int. Teletraffic Congress (ITC-17) Proceedings (September 2001). Unfortunately such prior art schedulers were developed by assuming an infinite backlog for each user at the base station or an inherent fairness expectation from users, assumptions which are not true with real-time streaming services, which generate sporadic packet arrivals with limited profile rates. By assuming infinite traffic-backlog, current scheduler designs may not be as work-conserving as desired given the sporadic real-time traffic arrivals—and may cause excessive packet losses with poor-channel users, thereby resulting in depleted or empty queues and efficiency degradation. Moreover, such prior art schedulers consider channel-dependency and quality of service (QoS) with inherent fairness constraints that may be suitable for best-effort services only. Accordingly, current systems do not provide robust real-time QoS guarantees, such as packet delay and jitter, when the system is overloaded, e.g., due to users' mobility, etc.

It would be advantageous to provide an improved scheduler with improved QoS (delay and loss) and system efficiency over a wide range of system loads. It would also be advantageous for the scheduler to be able to support differentiated services among heterogeneous users.

### SUMMARY OF INVENTION

A real-time scheduler is disclosed for packet data services in a wireless communication network. The real-time scheduler attempts to minimize the delay-incurred cost for the real-time packets over each scheduling interval. The scheduler can provide three levels of differentiation: inter-packet, intra-user, and inter-user. The real-time scheduler performs intra-user differentiation by searching for a queued packet or packets which provides a maximum cost deduction deliverable by each user. Where packet segmentation is allowed, the scheduler can sort the queued packets and pack the packets or segments until the queue depletes or channel capacity for this interval is filled up. Where packet segmentation is not allowed, the scheduler can perform approximation. Given the intra-user results, the real-time scheduler performs inter-user differentiation by comparing the intra-user results to derive the user who derives the maximum cost deduction. Note that the cost function can be defined in a manner to provide inter-packet differentiation. The scheduler can be implemented over, but is not limited to, a time division multiplexed (TDM) channel.

A hierarchical scheduler is also disclosed for packet data services in a wireless communication network. The hierarchical scheduler uses a real-time scheduler, such as the one described above, to prioritize time-critical real-time users. The hierarchical scheduler then uses another tier scheduler to exploit residual resources for high system efficiency. The hierarchical scheduler thereby provides QoS at both fine and coarse levels according to users' expectation, compromising between traffic multiplexing gain, multiuser diversity gain, and multi-class QoS differentiation.

These and other advantages of the invention will be apparent to those of ordinary skill in the art by reference to the following detailed description and the accompanying drawings.

### BRIEF DESCRIPTION OF DRAWINGS

FIG. 1 is a flowchart of processing performed by a real-time scheduler, in accordance with an embodiment.

FIG. 2 illustrates how the real-time weights for the cost function vary as a function of packet delay d for class s with exemplary schedulers corresponding to different weight functions.

FIG. 3 is a block diagram illustrating the architecture of a hierchical scheduler, in accordance with another embodiment.

FIG. 4 is a flowchart of processing performed by the hierarchical scheduler of FIG. 3.

FIG. 5 illustrates how non-real-time weights for the cost function vary as a function of normalized mean throughput, with exemplary schedulers corresponding to different weight functions.

### DETAILED DESCRIPTION

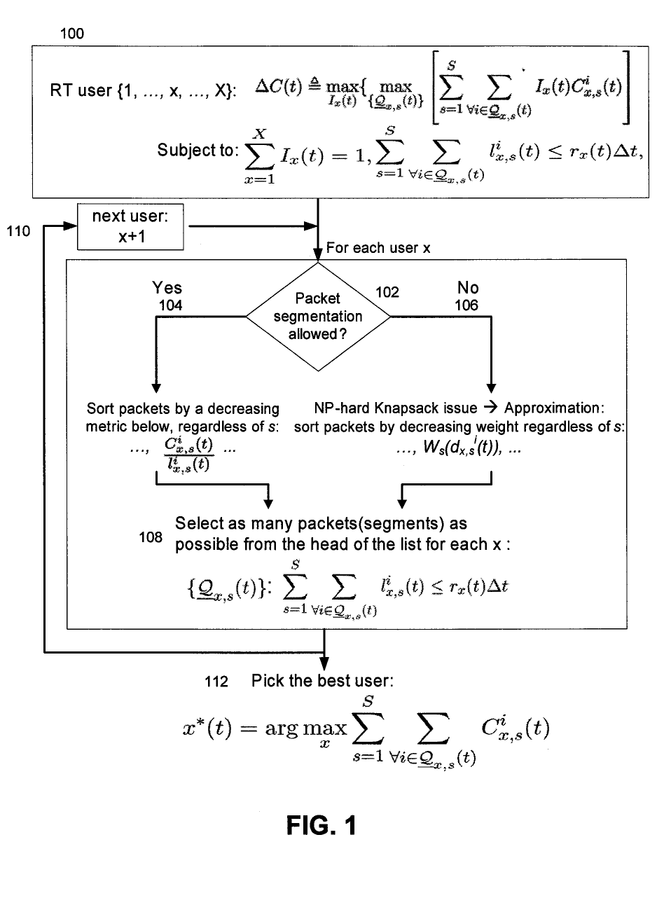

FIG. 1 is a flowchart of processing performed by a real-time scheduler in a wireless packet data communication system.

It is assumed, without limitation, that the packet data system provides each packet data user kεK={1, . . . , K} with access to a time-slotted shared communication channel. At each time slot t, the real-time scheduler picks a user k*(t) for transmission based on the channel and quality-of-service (QoS) information. Each user has an instantaneous supportable channel rate of rₖ(t) and may have up to S classes of traffic, with priority or delay tolerance sorted in an decreasing order of 1, . . . , s, . . . , S. Each class of a user is assumed to occupy a dedicated first-in-first-out (FIFO) queue at the base station. In practice, a user may have multiple classes of traffic at the same time. For clarity, it is useful to define the following system and QoS parameters:
Q_{k,s}(t)={0, . . . , i, . . . , n_{k,s}(t)}, is the set of backlogged packets in the queue of (k,s). Each packet is identified by p_{k,s}ⁱ(t) with the packet index i, class ID s; and user ID k at time t. Each set is sorted in an increasing order of their arrival time, where the packet index i=0 means an empty queue, i=1 refers to the head-of-line (HOL) packet, i=n_{k,s}(t) refers to the last packets in the FIFO queue.
Q_{k,s}(t) is the (index) subset of Q_{k,s}(t) denoting the packets that are selected for transmission from the queue (k,s) at time t.
l_{k,s}ⁱ(t) is the (residual) length of packet p_{k,s}ⁱ(t) in bits.
Δl_{k,s}ⁱ(t) is the length of already-transmitted segments from the packet p_{k,s}ⁱ(t).
m_{k,s} and mₖ: m_{k,s} is the mean profile rate or the minimum rate for a flow belonging to class s of user k, respectively, both in kbps. mₖ is the per-user profile or minimum rate, a summarization of m_{k,s} among all the active flows belonging to user k.
Dₛ: packet delay budget at the cellular access for a packet from class s.
d_{k,s}ⁱ(t): the queuing delay of packet p_{k,s}ⁱ(t) ever since its initial arrival at the base station. Note that it includes the retransmission delay because packets under retransmission are ahead of other packets in the queue.
βₛ: the probabilistic upper bound of deadline-violation incurred real time packet losses, defined as:
   P(d_{k,s}ⁱ(t)≧Dₛ)≦βₛ, ∀k and ∀i. (1)
Note that each real time packet upon violating d_{k,s}ⁱ(t)≧Dₛ will be removed immediately from the buffer and counted as a lost packet.
T_{k,s}(t) and Tₖ(t): T_{k,s}(t) is the up-to-date mean goodput (throughput) in kbps for class s of user k. The per-user goodput (throughput) Tₖ(t) is defined as Σₛ₌₁^{S}T_{k,s}(t).

To provide fine-grained QoS differentiation, the real-time scheduler can prioritize packet transmissions at three levels: intra-class (i.e., inter-packets), intra-user (i.e., inter-class), and inter-user. It is useful to define the scheduling goal for the real-time services as:
min{delay-incurred cost of all packets}. (2)
A fine-grained defined total cost function at time t is constituted by the cost of individual packets currently queued at the base station:

$$C ( t ) {=}^{△} {\sum }_{k = 1}^{K} [ {\sum }_{s = 1}^{S} {\sum }_{i = 0}^{{n}_{k , s} ( t )} {C}_{k , s}^{i} ( t ) ] , \qquad ( 3 )$$

where C_{k,s}ⁱ(t), a function of l_{k,s}ⁱ(t), Δl_{k,s}ⁱ(t), and d_{k,s}ⁱ(t), denotes the cost of queued packet p_{k,s}ⁱ(t) at time t. A successfully delivered real-time packet is a packet which has all of its bits transmitted to the user before the deadline expires. In other words, a larger packet or a partially delivered packet would “cost” more if delayed further than a smaller or not-yet-transmitted packet.

The delay-incurred cost for a real-time packet p_{k,s}ⁱ(t) can be defined in many different advantageous ways. The following are useful guidelines:
The total cost C(t) increases monotonically with l_{k,s}ⁱ(t) and Δl_{k,s}ⁱ(t), i.e., the length of residual and already-transmitted segments of this packet.
The unit cost per bit increases monotonically with d_{k,s}ⁱ(t), i.e., the waiting time since the packet's arrival at the base station.
The cost is non-negative and reaches maximum when d_{k,s}ⁱ(t)→Dₛ, i.e., when the packet is going to be dropped from the queue for delay violation.
The cost function C_{k,s}ⁱ(t) differentiates (the urgency of) packets within each class s, and prioritizes heterogeneous classes as well.
As a simple example, we may define the cost of each (residual) packet as follows:

$${C}_{k , s}^{i} ( t ) {=}^{△} {W}_{s} ( {d}_{k , s}^{i} ( t ) ) {l}_{k , s}^{i} ( t ) ( 1 + \frac{γ Δ {l}_{k , s}^{i} ( t )}{{l}_{k , s}^{i} ( t ) + Δ {l}_{k , s}^{i} ( t )} ) , \qquad ( 4 )$$

where γ≧0 is the factor of already-transmitted segment Δl_{k,s}ⁱ(t) in determining the cost of remaining segment l_{k,s}ⁱ(t); Wₛ(d_{k,s}ⁱ(t)) by definition is a non-decreasing weight, which is the unit cost of delay per bit. Wₛ(•) denotes a class-differentiated latency cost, i.e., it has a fixed format for each class s, provides inter-packet or intra-class differentiation among packets (of varying delay) from the same class, and remains independent of packet index i or time t.

FIG. 1 shows how the real-time scheduler performs intra-user and inter-user differentiation. Minimizing total cost means maximizing cost deduction. Accordingly, the real-time scheduler locates a user x*(t) who delivers the maximum cost deduction, which can be expressed as:

$$\begin{matrix}Δ C ( t ) {=}^{△} {max}_{{I}_{𝓍} ( t )} \{ {max}_{\{ {\underline{Q}}_{𝓍 , s} ( t ) \}} ⌊ {\sum }_{s = 1}^{S} {\sum }_{∀ i ∈ {\underline{Q}}_{𝓍 , s} ( t )} {I}_{𝓍} ( t ) {C}_{𝓍 , s}^{i} ( t ) ⌋ \} , & ( 5 ) \\ {\sum }_{𝓍 = 1}^{X} {I}_{𝓍} ( t ) = 1 , & ( 6 ) \\ {\sum }_{s = 1}^{S} {\sum }_{∀ i ∈ {\underline{Q}}_{𝓍 , s} ( t )} {l}_{𝓍 , s}^{i} ( t ) \leq {r}_{𝓍} ( t ) Δ t , & ( 7 )\end{matrix}$$

where Q_{x,s}(t) refers to the index subset of packets which are to be dequeued from the real-time buffer s of user x, suppose x is to be scheduled; Δt is the size of a time slot; Iₓ(t) is the 0-1 indicator: Iₓ(t)=1 denotes that user x is to be scheduler at time t. The inventors refer to this as a real-time maximum cost deduction (“rt-MCD”) scheduler.

As depicted in FIG. 1, equation (5) can be solved in two optimization steps: one pursued within each user x, another done by comparing all the users.

For user x independently, the real-time scheduler pursues intra-user or inter-class cost optimization. It scans all the queues of packets Q_{x,s}(t), ∀s to select a subset Q_{x,s}(t) for each. Under the constraint of (7), the scanning derives the largest cost deduction deliverable by user x, i.e., the optimal packet (segment) subsets from all classes:

$$\{ {\underline{Q}}_{𝓍 , s} ( t ) \} = arg {max}_{\{ {\underline{Q}}_{𝓍 , s} ( t ) \}} {\sum }_{s = 1}^{S} {\sum }_{∀ i ∈ {\underline{Q}}_{𝓍 , s} ( t )} {C}_{𝓍 , s}^{i} ( t ) .$$

Suppose no packet can be segmented, i.e., Δl_{x,s}ⁱ(t)=0 and C_{x,s}ⁱ(t)=Wₛ(d_{x,s}ⁱ(t))l_{x,s}ⁱ(t), for any queued packets. Then, as illustrated at 106, the issue is to find the packet subsets who has the largest cost and who may fill the transmission capacity rₓ(t)Δt as much as possible. This optimization issue is an NP-hard Knapsack issue and may be solved with approximation: the scheduler selects packets starting from the head of a sorted list, where packets from all the classes/queues are ranked by decreasing Wₛ(d_{x,s}ⁱ(t)). The selection continues at 108 until the list depletes or capacity rₓ(t)Δt in (7) is filled up by the selected packets. The complexity of the approximation is O(N log(N)), where N is the total number of queued packets for user x.

On the other hand, if packet segmentation is allowed, the intra-user optimization issue becomes much simpler: the scheduler, as illustrated by 104 in FIG. 1, first sorts the queued packets from all real-time classes in a single list with decreasing

$$\frac{{C}_{𝓍 , s}^{i} ( t )}{{l}_{𝓍 , s}^{i} ( t )} .$$

It then, at 108, selects packets or segments starting from the head of the list as before until the queue depletes or this slot is packed with rₓ(t)Δt bits. Note that the last packed packet may only be a segment, i.e., partially transmitted.

Given the subsets of {Q_{x,s}(t), ∀s} for each user x, the real-time scheduler pursues the inter-user optimization at 112 by comparing the intra-user results obtained before, which derives the largest-result or best user x*(t) (i.e., Iₓ*(t)=1):

$${𝓍}^{*} ( t ) = arg {max}_{𝓍} {\sum }_{s = 1}^{S} {\sum }_{∀ i ∈ {\underline{Q}}_{𝓍 , s} ( t )} {C}_{𝓍 , s}^{i} ( t ) ,$$

i.e., the user who derives the largest cost-deduction at time t. With the constraint (6), it should take O(X) comparisons to find the best user.

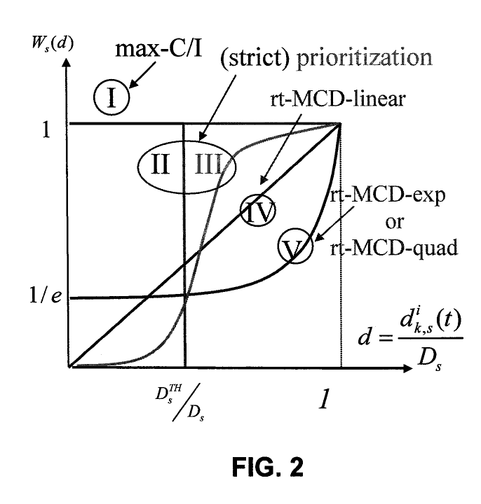

FIG. 2 illustrates an exemplary weight function Wₛ(d) which, as discussed earlier, differentiates packets from the same class by individual packet delay d, thereby providing intra-class or inter-packet differentiation. FIG. 2 plots Wₛ(d) with respect to normalized packet delay

$$\frac{{d}_{k , s}^{i}}{{D}_{s}} .$$

Each class is assumed to have a corresponding delay threshold Dₛ^{TH}, to tell whether the queued real-time packets are “time-critical”, i.e., whether d_{k,s}ⁱ(t)>Dₛ^{TH}. The weight may adopt different definitions, ranging from I to V, as shown in FIG. 2, with an increasing sensitivity to instantaneous RT packet delay for any RT user k:
Scheme I: by (3) and (4) and when γ=0, the constant weight (w) of scheme I implies C_{k,s}ⁱ(t)=wl_{k,s}ⁱ(t), i.e., a max-C/I scheduler which minimizes the total cost by selecting the best-channel user (packets) at any time slot t. It thus has no delay-based prioritization or class differentiation.
Scheme II and III: Suppose scheme II takes a step function:

$${W}_{s} ( d ) = \{ \begin{matrix}1 , & if d \leq {D}_{s}^{TH} , \\ w ( ⪢ 1 ) , & otherwise\end{matrix}$$
Then scheme II strictly prioritizes “time-critical” users, who has d>Dₛ^{TH}, ∃s, over other users. In each priority group of users, it behaves like a max-C/I. The “S”-shaped scheme III is similar to scheme II, but III supports a smoother migration between users with or without time-criticality.
Scheme IV (“rt-MCD-linear”): It is a linear relationship Wₛ(d)=ad_{k,s}ⁱ(t)+b, where a and b are constant. To support inter-class differentiation, a proper choice could be

$$a = \frac{1}{{D}_{s}} ,$$
b=0, with which

$${C}_{k , s}^{i} ( t ) = {d}_{k , s}^{i} ( t ) {l}_{k , s}^{i} ( t ) ( 1 + \frac{γ Δ {l}_{k , s}^{i} ( t )}{{l}_{k , s}^{i} ( t ) + Δ {l}_{k , s}^{i} ( t )} ) ,$$
revealing that the delay-centric cost is in proportion to packet length. Note that in a special case when packets from the same user are approximately identical in both length (denoted l) and delay expectation,

$${d}_{k , s}^{i} ( t ) \approx \frac{l}{{T}_{k} ( t )} ,$$
∀i, and ∀s. Then our real-time scheduler based on IV behaves like the proportional fairness (PF) scheduler. See A. Jalali et al., “Data Throughput of CDMA-HDR a High Efficiency-High Data Rate Personal Communication Wireless System,” IEEE Vehicular Technology Conference Proceedings (VTC), pp. 1854-58 (May 2000); P. Viswanath et al., “Opportunistic Beaforming using Dumb Antennas,” IEEE Trans. on Inform. Theory, 48(6), pp. 1277-94 (June 2002).
Scheme V: it reveals the ever-growing marginal increase of unit cost Wₛ(d) when packets are increasingly “time-critical”, i.e., when d→Dₛ. Then the scheduling of “time-critical” packets contributes most to the total cost deduction, and therefore a scheduler-based on V efficiently controls deadline-violated packet losses. Heuristically one may define a piecewise linear weight

$${W}_{s} ( d ) = \{ \begin{matrix} b \frac{d}{{D}_{s}^{TH}} , & if d \leq {D}_{s}^{TH} , \\ \frac{a ( d - {D}_{s}^{TH} )}{{D}_{s}} + b , & otherwise ,\end{matrix}$$
where a (>b) and b are positive control parameters. When b=1, the scheduler based on this scheme behaves like PF among non-time-critical users, if there is no time-critical users. Otherwise, the scheduling priority of packets increases with packet delay at a different speed, say, a=0.5 and b=3, according to time-criticality.
Other definitions of V include a quadratic weight

$${W}_{s} ( d ) = {a ( \frac{d}{{D}_{s}} )}^{α}$$
(say, α=2) (referred to herein as “rt-MCD-quad”), or an exponential weight

$${W}_{s} ( d ) = a {ⅇ}^{\frac{bd}{{D}_{s}}}$$
(referred to herein as “rt-MCD-exp”), where the constant a and b (or α) may be fixed regardless of user or class ID. On the other hand, a and b may be set according to user and class-specific long- and short-term performance. Note that all packets are tagged with both user ID (k) and class ID (s). For example, the EXP-Rule (see S. Shakkottai et al., “Scheduling Algorithms for a Mixture of Real-time and Non-real-time Data in HDR,” 17th Int. Teletraffic Congress Proceedings (ITC-17) (September 2001)) takes the exponential format with:

$$\begin{matrix}a = \frac{{δ}_{s}}{{T}_{k} ( t )} , where {δ}_{s} = \frac{- ln {β}_{s}}{{D}_{s}} , & ( 8 ) \\ b = \frac{{D}_{s} {δ}_{s}}{1 + \sqrt{\frac{{\sum }_{k} {\sum }_{s} d {δ}_{s}}{K}}} . & ( 9 )\end{matrix}$$
Note that in the EXP-rule, d refers to head-of-line (HOL) packet delay, i.e., all packets in one queue are assumed of the same delay, and each user k has exactly one class of traffic. Similar to IV, considering

$$d ∼ \frac{1}{{T}_{k} ( t )}$$
and given identical Dₛ, ∀s, we can show that the real-time scheduler based on a quadratic weight behaves like the Alpha-Rule scheduler (see A. Sang et al., “Downlink Scheduling Schemes in Cellular Packet Data Systems of Multiple-Input Multiple-Output Antennas,” IEEE GLOBECOM Proceedings (November 2004)).

The above-described real-time scheduler was designed for real-time services. It sacrifices long-term system efficiency for fine-grained, small-timescale delay (QoS) guarantees. As such, it may actually work poorly in supporting non-real-time metrics, such as flow-level, large timescale fairness, aggregate throughput, or minRate guarantees.

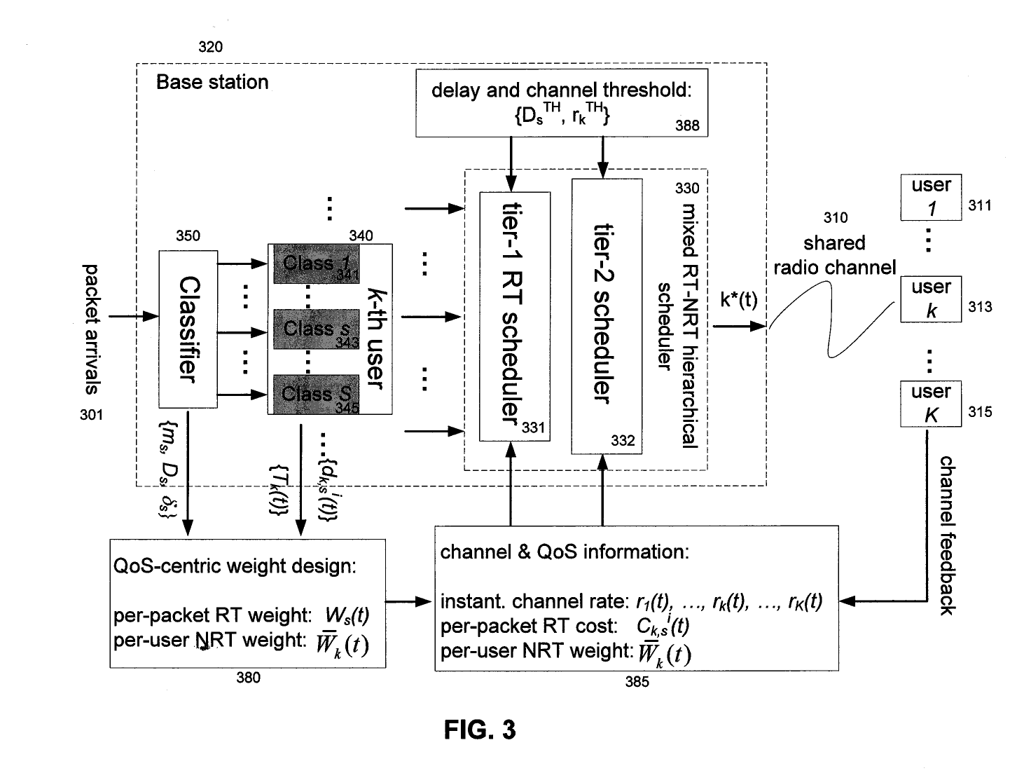

FIG. 3 is a block diagram illustrating the architecture of a hierarchical scheduler which serves to differentiate the QoS of real-time and non-real-time users at different time-scales with different granularity. The hierarchical scheduler 330 integrates the above-described real-time scheduler 331 with a lower tier scheduler 332. In FIG. 3, a base station 320 is depicted which receives packets 301 and schedules both real-time and non-real-time services to users 311, . . . , 313, . . . , 315 across a shared communication channel 310. The packets 301 are classified at a classifier 340 and assigned to queues 341, . . . 343, . . . 345 for each user 340. At each time slot, the hierarchical scheduler 330 selects users based on time-varying location-dependent channel states, delay-centric cost (weight) of individual real-time packets, and the up-to-date rate achievements for non-real-time flows. The hierarchical scheduler 330 comprises two (or more) tiers: a first tier fine-grained scheduler 331 which picks a time-critical real-time user by exploiting instantaneous channel quality and packet delay; and a second tier low-priority scheduler 332 which exploits the residual resources beyond the first tier and which finds an optimal user based on large-timescale metrics, such as per-user throughput and fairness. The tier one scheduler 331 can be adapted to operate in accordance with the above-described real-time scheduler, e.g., using any of the rt-MCD schemes discussed above. The lower tier scheduler 332 can be adapted to operate in accordance with any existing schedulers, such as EXP-rule, or, alternatively, can operate in accordance with the scheduler design to be discussed below in further detail.

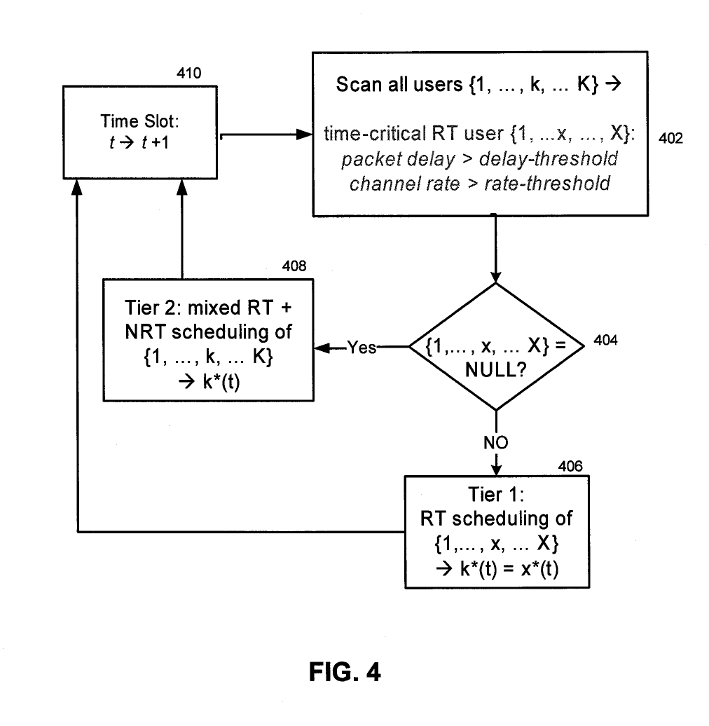

FIG. 4 is a flowchart of processing performed by the hierarchical scheduler. At time slot t, the base station at 402 scans K={1, . . . , k, . . . , K} to locate good-channel time-critical real-time users—{1, . . . , x, . . . , X}, each satisfies rₓ(t)>rₓ^{TH} and max_{∀s∀i}d_{x,s}ⁱ(t), ∀i>Dₛ^{TH}, where rₓ^{TH} and Dₓ^{TH} are channel and delay threshold. Given a non-empty {1, . . . , x, . . . , X} at 404, the first tier real-time scheduler is invoked at 406 to schedule the good-channel time-critical real-time users. If {1, . . . , x, . . . , X}=NULL at 404, the real-time scheduler is skipped and the lower tier scheduler is invoked at 408.

Accordingly, the system has the flexibility to handle mixed real-time and non-real-time users or classes, purely real-time users, purely non-real-time users with or without minRate requirements. For example, when there are no non-real-time users, tier one of the hierarchical scheduler may be set to Dₛ^{TH}=0 and rₖ^{TH}=0 on-the-fly. Then the hierarchical scheduler becomes a work-conserving, pure real-time scheduler (tier one) with fine-grained packet delay guarantee. On the other hand, when there are only non-real-time users, the tier one would not be triggered because {1, . . . , x, . . . , X}=NULL. So the scheduler gracefully degrades to tier two, working towards high efficiency and long-term QoS. Suppose multiple real-time and non-real-time users co-exist. The hierarchical scheduler behaves differently in response to different system states: It first works as a purely tier one scheduler among time-critical real-time users, if any, to provide them immediate services at a cost of global system efficiency. The two thresholds, Dₛ^{TH} and rₖ^{TH}, balances between the delay sensitivity and system efficiency. On the other hand, when the system is lightly loaded or none of real-time users is time-critical, the scheduler switches to tier two in order to focus on long-term minRate and efficiency achievement, instead of the packet-level delay guarantee. Hence, the hierarchical scheduler provides mixed real-time and non-real-time users with both fine-grained QoS awareness at the packet level and long-term system efficiency at the flow or user level.

The lower tier scheduler needs to satisfy non-real-time metrics while at the same time protecting co-existing, “non-time-critical” real-time users from excessive queue buildup or even packet loss. An embodiment of the lower tier scheduler may be designed to operate as follows.

Similar to the formulation of the above-described real-time scheduler, the lower tier scheduler can be adapted to maximize the cost deduction of packet waiting time in the system. At time t and given all the real-time and non-real-time user set K={1, . . . , k, . . . , K}, the large timescale, rate-based tier-two non-real-time MCD scheduler (referred to herein as “nrt-MCD”) works to find the maximum cost deduction:

$$\begin{matrix}Δ C ( t ) {=}^{Δ} {max}_{{I}_{k} ( t )} \{ {max}_{\{ {\underline{𝒬}}_{k , s} ( t ) , ∀ s \}} {\overline{W}}_{k} ( t ) [ {\sum }_{s = 1}^{S} {\sum }_{∀ i ∈ {\underline{𝒬}}_{k , s} ( t )}^{} {I}_{k} ( t ) {C}_{k , s}^{i} ( t ) ] \} , & ( 10 ) \\ {\sum }_{k = 1}^{K} {I}_{k} ( t ) = 1 , & ( 11 ) \\ {\sum }_{s = 1}^{S} {\sum }_{∀ i ∈ {\underline{𝒬}}_{k , s} ( t )}^{} {l}_{k , s}^{i} ( t ) \leq {r}_{k} ( t ) Δ t , & ( 12 ) \\ {T}_{k} ( t ) = \frac{1}{t} {\sum }_{τ = 1}^{t} {r}_{k} ( τ ) {I}_{k} ( τ ) , & ( 13 )\end{matrix}$$

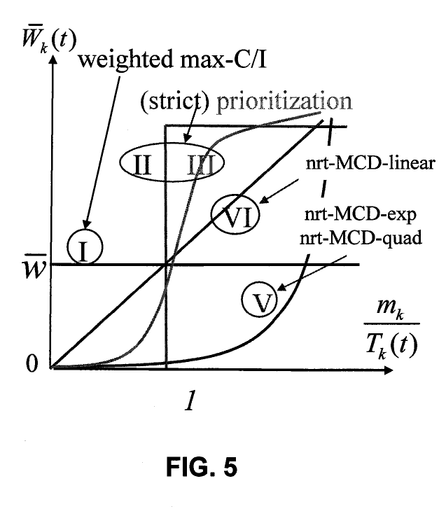

Given the same definition of Q_{k,s}(t), Δt, and the scheduling decision indicator Iₖ(t) as described above, this formulation differs from the real-time formulation in equation (5) by the addition of normalized long-term, per-user unit cost (weight) W̅ₖ(t) here in equation (10). It is useful to compare FIG. 2, which illustrates the real-time weight function, with FIG. 5, which illustrates the non-real-time weight function. FIG. 5 shows the non-real-time weight W̅ₖ(t), i.e., the unit mean latency cost per bit, as a function of normalized mean throughput

$$\frac{{m}_{k}}{{T}_{k} ( t )}$$

of user k. In FIG. 5, W̅ₖ(t) as a function of

$$\frac{{m}_{k}}{{T}_{k} ( t )}$$

corresponds to Wₛ(d) as a function of

$$\frac{{d}_{k , s}^{i} ( τ )}{{D}_{s}}$$

in FIG. 2. In FIG. 5, w̅ is a constant, mₖ as defined before is the minimum or profile rate requirement by user k. Hence the nrt-MCD scheduler imposes the long-term inter-user differentiation by forcing the per-user mean throughput Tₖ(t) to be proportional to mₖ, while the channel-dependency in (12) guarantees a high efficiency.

In equation (10), Wₛ(d_{k,s}ⁱ(t)) as a factor in C_{x,s}ⁱ(t) captures fine-grained QoS as before, but here for the non-time-critical users. Therefore, we may simply fix it as Wₛ(d)=w (constant), when there are mixed real-time and non-real-time users or non-real-time users only, or

$${W}_{s} ( \frac{{d}_{k , s}^{i} ( t )}{{D}_{s}} ) = \frac{{d}_{k , s}^{1} ( t )}{{D}_{s}}$$

(normalized HOL delay), ∀i, when there are purely real-time users. Here each user's HOL packet refers to the longest-waiting packet among all FIFO queues of this user. Note when defining Wₛ(d)=w, the nrt-MCD scheduler becomes delay-insensitive, and depends only on long-term weight W̅_{K}(t) and instantaneous channel rate rₖ(t), whence it provides coarse-granularity QoS for non-real-time and (non-time-critical) real-time users alike.

For simplicity, suppose Wₛ(d)=w. Then equation (10), which derives the tier two nrt-MCD scheduler, may be solved as follows, similar to the tier-one rt-MCD scheduler:
1. At time t and for each user k, the tier-two nrt-MCD scheduler first pursues the intra-user or inter-class optimization. It first selects the longest-waiting packet subsets {Q_{k,s}(t), ∀s}, i.e., packets from the head of FIFO queues, under the constraint of equation (12). The number of packets selected from each FIFO queue is decided by intra-user scheduling rules, which could be any well-known wireline scheduling algorithm, e.g., weight fair queueing (WFQ) (A. Demers et al., “Analysis and Simulation of a Fair Queueing Algorithm,” ACM SIGCOMM, pp. 1-12 (September 1989)), or the Max-Min fairness (D. Bertsekas and R. Gallagher, “Data Networks,” Prentice-Hall (1992)) (Note that with Max-Min fairness, and assuming one flow per class and sufficient packet backlog per queue, the number of packets from each flow is proportional to

$$\frac{{m}_{k , s}}{{m}_{k}} .$$
For generic cases, detailed solution can be obtained, see A. Sang et al., “Weighted Fairness Guarantee for Scalable Diffserv Assured Forwarding,” IEEE Int. Conf. Commun. Proceedings (ICC), pp. 2365-69 (June 2001)) In short, this step fills the instantaneous transmission capacity rₖ(t)Δt with the oldest packets.
2. Given {Q_{k,s}(t), ∀s} of each user k, the tier-two nrt-MCD scheduler does inter-user optimization. The solution is an optimal indicator set {Iₖ(t), ∀k} by equation (10). In other words, it locates the unique, optimal user k*(t) as follows:

$${k}^{*} ( t ) = arg {max}_{k} {\overline{W}}_{k} ( t ) [ {\sum }_{s = 1}^{S} {\sum }_{∀ i ∈ {\underline{𝒬}}_{k , s} ( t )} {I}_{k} ( t ) {l}_{k , s}^{i} ( t ) ( 1 + \frac{γ Δ {l}_{k , s}^{i} ( t )}{{l}_{k , s}^{i} ( t ) + Δ {l}_{k , s}^{i} ( t )} ) ] .$$

Note that the maximum scheduling gain, in terms of cost deduction as before, transforms to maximum net increase of service utility in the system. Given a non-decreasing concave utility as a function of per-user mean throughput, an optimal scheduling algorithm for non-real-time services can be formulated as:

$$\begin{matrix}{max}_{\{ {I}_{k} ( t ) , ∀ k \}} U ( t ) , & ( 14 ) \\ s . t . U ( t ) = {\sum }_{k = 1}^{K} {U}_{k} ( {T}_{k} ( t ) ) , \\ {\sum }_{k = 1}^{K} {I}_{k} ( t ) = 1 , & ( 15 )\end{matrix}$$

where Tₖ(t) is defined the same as (13) for the NRT scheduler. See A. Sang et al., “Downlink Scheduling Schemes in Cellular Packet Data Systems of Multiple-Input Multiple-Output Antennas,” IEEE GLOBECOM Proceedings (November 2004). A generic form of utility function for (best effort) non-real-time services may be expressed as follows:

$${U}_{k} ( {T}_{k} ( t ) ) = {w}_{k} \frac{{{T}_{k} ( t )}^{1 - α}}{1 - α} , \qquad ( 16 )$$

where wₖ is per-user weighting factor. See J. Mo et al., “Fair End-to-End Window-Based Congestion Control,” IEEE/ACM Trans. Networking, 8(5): 556-67 (October 2000). The weighted Alpha-rule scheduling technique optimizes the above goal step-by-step:

$${I}_{k} ( t ) = \{ \begin{matrix}1 , & if k = arg {max}_{k ∈ K} {w}_{k} \frac{{r}_{k} ( t )}{{{T}_{k} ( t - 1 )}^{α}} , \\ 0 , & otherwise .\end{matrix} \qquad ( 17 )$$

Note that this formulation does not have the constraint (12), i.e., it assumes infinite data backlog per non-real-time user. The long-term, user-specific weight W̅ₖ(t), denoted wₖ here, can be designed to differentiate users according to minRate mₖ. One example of such a design is the M-LWDF algorithm (see M. Andrews et al., “Providing Quality of Services over a Shared Wireless Link,” IEEE Commun. Mag., pp. 150-54 (February 2001)) for non-real-time services, where the time-varying Wk represents the t-moment depth of a token bucket accompanying each user k—its token arrives at a constant rate of mₖ, while its leaking rate is k's actual throughput, i.e., rₖ(t)Iₖ(t) at the current time slot, or Tₖ(t) in a long run. Note that such a weight design in non-real-time M-LWDF assumes the same delay tolerance among all users.

FIG. 5 plots some exemplary definitions of per-user non-real-time weight W̅ₖ(t) for nrt-MCD schedulers. As in the discussion above of per-class real-time weight Wₛ(d) in FIG. 2, we can draw similar conclusions for W̅ₖ(t) as follows:
Scheme I is a constant weight. The tier-two nrt-MCD scheduler based on I is equivalent to the weighted Alpha-Rule with α=0 (i.e., max-C/I), if taking

$$\overline{w} = \frac{{w}_{k}}{{m}_{k}} ,$$
and assuming infinite data backlog for each user k.
Scheme II is a step function:

$${\overline{W}}_{k} ( t ) = \{ \begin{matrix} 1 , & if \frac{{m}_{k}}{{T}_{k} ( t )} \leq 1 , or no {m}_{k} specified , \\ constant ( ⪢ 1 ) , & otherwise .\end{matrix}$$
The step function says that once per-user throughput exceeds the minRate or profile rate, the lower tier scheduler degenerates to purely max-C/I and thus achieves high efficiency. Otherwise, the scheduler assigns high priority to users who have not met the long-term expectation of Tₖ(t)≧mₖ. For an non-real-time user k who does not specified mₖ, we let W̅ₖ(t)=1, which implies that this user is served only after the minRate of other users are satisfied. The “S”-shaped scheme III works similarly as II, but it enables a more graceful degeneration.
Scheme IV as a linear function (“nrt-MCD-linear”) derives the weighted Alpha-Rule with α=1 (i.e., like a weighted PF algorithm), if assuming

$${w}_{k} = {m}_{k} , {\overline{W}}_{k} ( t ) = \frac{{m}_{k}}{{T}_{k} ( t )} ,$$
and infinite data backlog. If slope of the line is set as Wₖ/Mₖ, where the time-varying, user-specific wₖ is the t-moment token depth as in M-LWDF, then III derives exactly the M-LWDF algorithm.
Scheme V derives the weighted Alpha-Rule with generic α≧1, if assuming a quadratic relationship

$${\overline{W}}_{k} ( t ) = {( \frac{{m}_{k}}{{T}_{k} ( t )} )}^{α}$$
(with α=2) (“nrt-MCD-exp”), with infinite data backlog and an adaptive coefficient

$$\frac{{w}_{k}}{{m}_{k}^{α}} ,$$
as designed by non-real-time M-LWDF. Similar to the scheme V of the above-described real-time weight design in FIG. 2, W̅ₖ(t) may be piece-wise linear like the scheme V of real-time weight, or alternatively:

$${\overline{W}}_{k} ( t ) = \{ \begin{matrix} 1 , & if \frac{{m}_{k}}{{T}_{k} ( t )} < 1 , \\ a \frac{{m}_{k}}{{T}_{k} ( t )} + 1 - a , & otherwise ,\end{matrix}$$
where a is a positive control parameter. The scheduler based on the above piece-wise linear weight behaves like weighted PF if mₖ≦Tₖ(t) for all users, or max-C/I if mₖ>Tₖ(t), ∀k, or somewhere in between if otherwise, but with high-priority scheduling for users with unsatisfied minRate guarantee. Comparatively an exponential W̅ₖ(t) (“nrt-MCD-exp”) would provide a scheduler with even better minRate performance.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents.

What is claimed is:

1. A method for scheduling packets in a wireless communication system providing packet data service across a shared communication channel, the method comprising the steps of:
receiving packets which have been queued by service classification per user;
performing intra-user differentiation by sorting each user's packets by cost deduction deliverable in accordance with a cost function, the cost function representing a delay-incurred cost of a queued packet, and packing the packets into a transmission slot's transmission capacity; and
performing inter-user differentiation by comparing intra-user results and selecting a user for transmission which derives a maximum cost deduction in accordance with the cost function.

2. The method of claim 1 wherein packet segmentation is allowed and wherein the sorting of each user's packets is performed in accordance with a metric defined by the cost function for the packet divided by the packet's residual length.

3. The method of claim 1 wherein the cost function is defined in terms of a weight which is defined for each service classification, thereby providing intra-class differentiation.

4. The method of claim 3 wherein packet segmentation is not allowed and the sorting of each user's packets is performed in accordance with an approximation based on the weight of the cost function for the packets where the weight represents a class-differentiated latency cost.

5. The method of claim 3 wherein the weight varies as the packet's queue delay approaches a delay threshold.

6. The method of claim 1 wherein the communication channel is shared using time-division multiplexing.

7. A method for scheduling packets in a wireless communication system providing packet data service across a shared communication channel, the method comprising the steps of:
receiving packets which have been queued by service classification per user;
scanning for time-critical real-time packets and applying a real-time scheduler to said time-critical real-time packets, the real-time scheduler selecting packets which derive a maximum cost deduction in accordance with a cost function representing a delay-incurred cost of a queued packet; and
if no such time-critical real-time packets exist, applying a lower tier scheduler to remaining queued packets so as to exploit residual scheduling resources to improve long-term system metrics.

8. The method of claim 7 wherein scanning for time-critical real-time packets comprises searching for packets with a target queuing delay which meets a delay threshold.

9. The method of claim 8 wherein the lower tier scheduler operates by protecting real-time packets which do not meet the delay threshold of the real-time scheduler from excessive queue buildup.

10. The method of claim 9 wherein the lower tier scheduler selects packets which derive a maximum cost deduction in accordance with a cost function representing a delay-incurred cost of a queued packet, the cost function defined in terms of a weight which varies with throughput.

11. The method of claim 7 wherein the communication channel is shared using time-division multiplexing.

12. A base station for a wireless communication system providing packet data service across a shared communication channel to one or more users, the base station comprising:
a packet classifier which classifies packets into one or more service classifications per user; and
a hierarchical scheduler which receives packets queued by service classification per user, the hierarchical scheduler further comprising
a real-time scheduler which prioritizes any time-critical packets in a first tier of the hierarchical scheduler in accordance with a short-term real-time metric as represented by a cost function representing a delay-incurred cost of a queued packet; and
a non-real-time scheduler which prioritizes any remaining packets using any residual scheduling resources in accordance with a long-term non-real-time system metric.

13. The base station of claim 12 wherein the real-time scheduler operates by:
performing intra-user differentiation by sorting each user's packets by cost deduction deliverable in accordance with the cost function and packing the packets into a transmission slot's transmission capacity; and
performing inter-user differentiation by comparing intra-user results and selecting a user for transmission which derives a maximum cost deduction in accordance with the cost function.
